(19) United States
(12) Patent Application Publication
(10) Pub. No.: US 2024/0255836 A1
(43) Pub. Date: Aug. 1, 2024

(54) PROJECTION APPARATUS

(71) Applicant: Coretronic Corporation, Hsin-Chu (TW)

(72) Inventors: Wen-Yen Chung, Hsin-Chu (TW); Tung-Chou Hu, Hsin-Chu (TW); Fan-Chieh Chang, Hsin-Chu (TW)

(73) Assignee: Coretronic Corporation, Hsin-Chu (TW)

(21) Appl. No.: 18/423,297

(22) Filed: Jan. 26, 2024

(30) Foreign Application Priority Data
Jan. 30, 2023 (CN) 202310044513.1

(51) Int. Cl. G03B 21/16; G03B 21/14

(52) U.S. Cl. CPC G03B 21/16; G03B 21/142

(57) ABSTRACT

A projection apparatus includes an illumination system, an optical engine module, a lens module, and a heat-dissipation module. The illumination system includes a light source configured to provide an illumination light beam. The optical engine module is disposed on a transmission path of the illumination light beam, and configured to convert the illumination light beam into an image light beam. The lens module is disposed on a transmission path of the image light beam, and configured to project the image light beam out of the projection apparatus. The lens module has an optical axis. The lens module is adapted to move between a first position and a second position along the optical axis. The heat-dissipation module includes a light source heat-dissipation fin connected to the light source. When the lens module moves, the light source, the light source heat-dissipation fin, and the optical engine move with the lens module.

### CROSS-REFERENCE TO RELATED APPLICATION

This application claims the priority benefit of Chinese application no. 202310044513.1, filed on Jan. 30, 2023. The entirety of the above-mentioned patent application is hereby incorporated by reference herein and made a part of this specification.

### BACKGROUND

### Technical Field

The disclosure relates to an optical device. Particularly, the disclosure relates to a projection apparatus.

### Description of Related Art

At present, since an ultra-short-throw projection apparatus provides only a fixed projection size, the flexibility and versatility of use of the ultra-short-throw projection apparatus are greatly reduced. To achieve the purpose that the ultra-short-throw projection apparatus moves projection, it is required that a light valve and a light source can be moved by the same distance as the lens does. However, this approach leads to a heat-dissipation module not able to effectively dissipate heat from the light source, reducing the overall heat dissipation effect of the ultra-short-throw projection apparatus, and affecting the projection quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a projection apparatus, including an illumination system, an optical engine module, a lens module, and a heat-dissipation module. The illumination system includes a light source, and is configured to provide an illumination light beam. The optical engine module is disposed on a transmission path of the illumination light beam, and is configured to convert the illumination light beam into an image light beam. The lens module is disposed on a transmission path of the image light beam, and is configured to project the image light beam out of the projection apparatus. The lens module has an optical axis, and the lens module is adapted to move between a first position and a second position along the optical axis. The heat-dissipation module includes a light source heat-dissipation fin connected to the light source. When the lens module moves, the light source, the light source heat-dissipation fin, and the optical engine module move together with the lens module.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection apparatus according to an embodiment of the disclosure.

FIG. 2A is a schematic perspective view of the projection apparatus of FIG. 1.

FIG. 2B is a top view of the projection apparatus of FIG. 2A.

FIG. 2C is a left side view of the projection apparatus of FIG. 2A.

FIG. 2D is a right side view of the projection apparatus of FIG. 2A.

FIG. 2E is a rear view of the projection apparatus of FIG. 2A.

FIG. 2F is a top view of a lens module of the projection apparatus of FIG. 2A after being moved.

FIG. 2G is a left side view of the lens module of the projection apparatus of FIG. 2A after being moved.

FIG. 2H is a right side view of the lens module of the projection apparatus of FIG. 2A after being moved.

FIG. 2I is a rear view of the lens module of the projection apparatus of FIG. 2A after being moved.

FIG. 3A is a schematic perspective view of a projection apparatus according to another embodiment of the disclosure.

FIG. 3B is a top view of the projection apparatus of FIG. 3A.

FIG. 3C is a left side view of the projection apparatus of FIG. 3A.

FIG. 3D is a right side view of the projection apparatus of FIG. 3A.

FIG. 3E is a rear view of the projection apparatus of FIG. 3A.

FIG. 3F is a top view of a lens module of the projection apparatus of FIG. 3A after being moved.

FIG. 3G is a left side view of the lens module of the projection apparatus of FIG. 3A after being moved.

FIG. 3H is a right side view of the lens module of the projection apparatus of FIG. 3A after being moved.

FIG. 3I is a rear view of the lens module of the projection apparatus of FIG. 3A after being moved.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a projection apparatus, which moves projection to adjust a size and a focal length of a projection image, and has a better heat dissipation effect.

Other purposes and advantages of the disclosure may be further understood from the technical features of the disclosure.

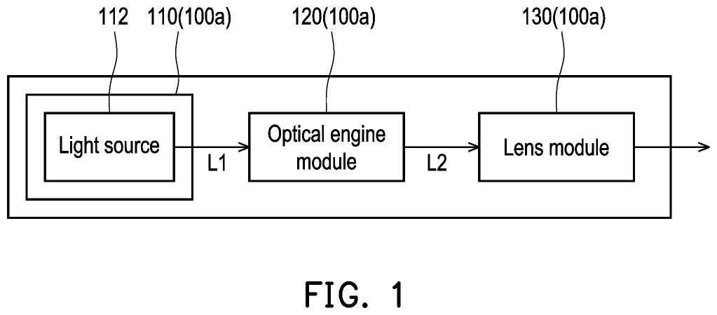

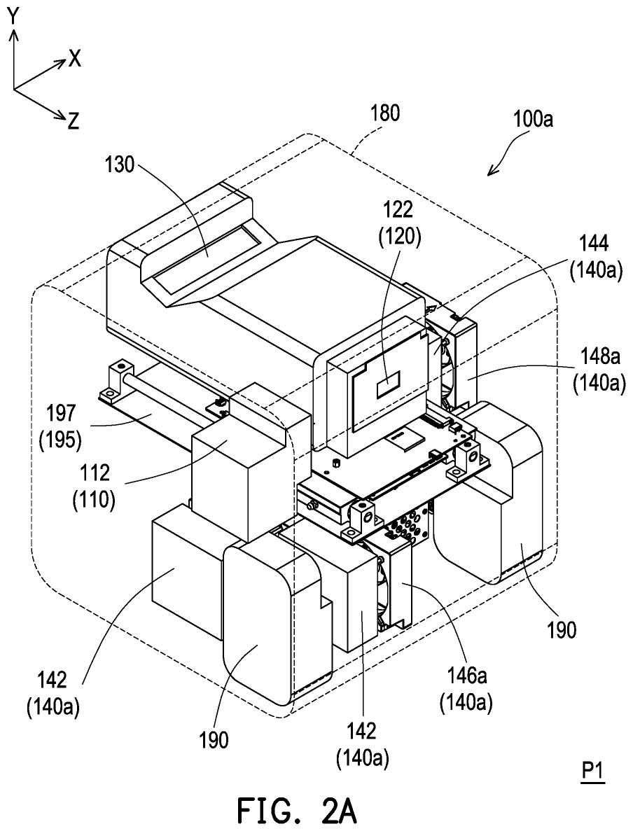

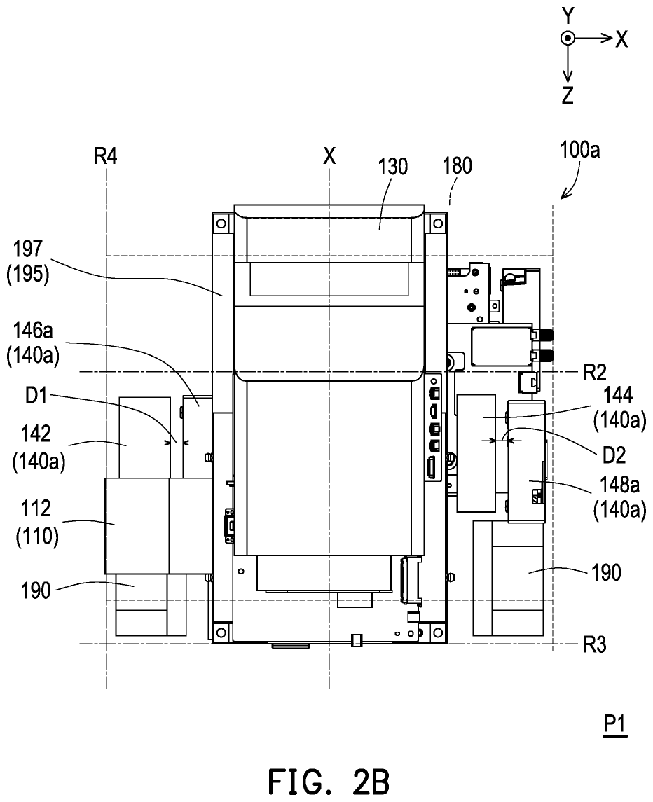

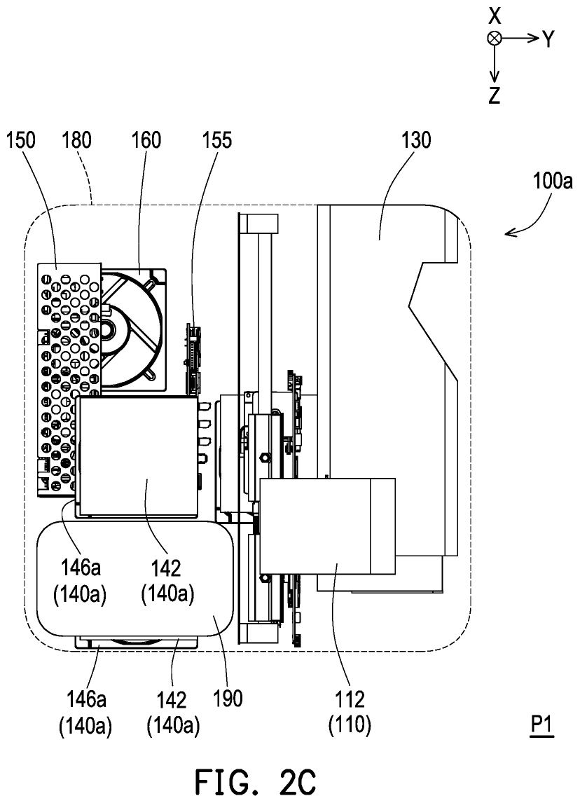

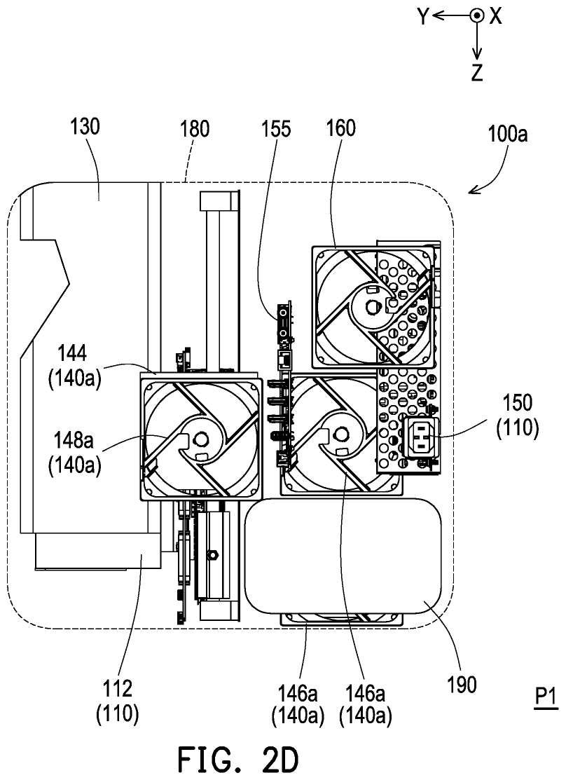

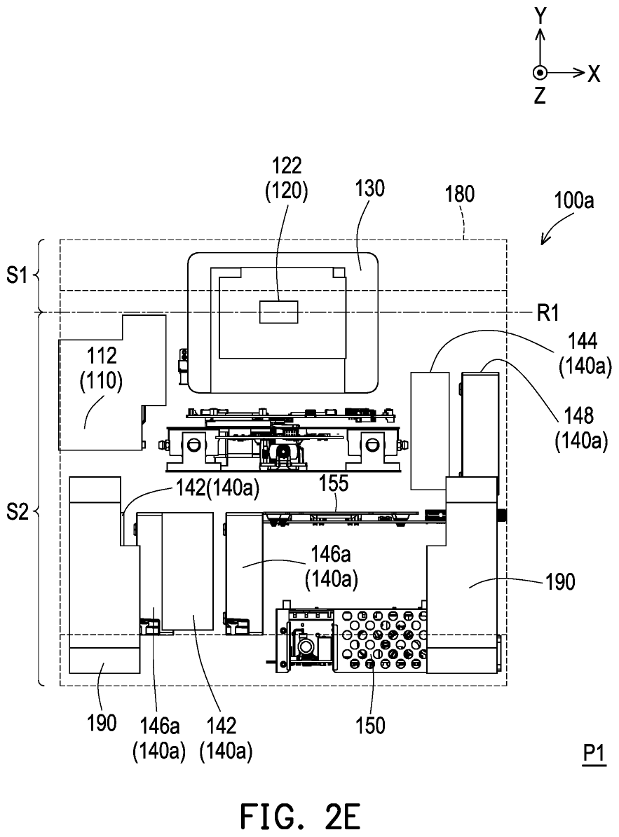

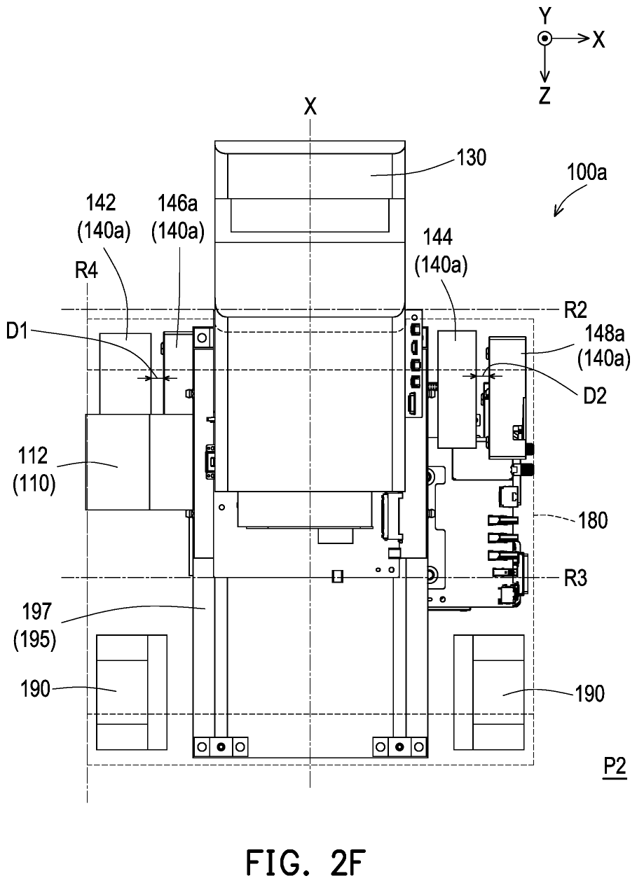

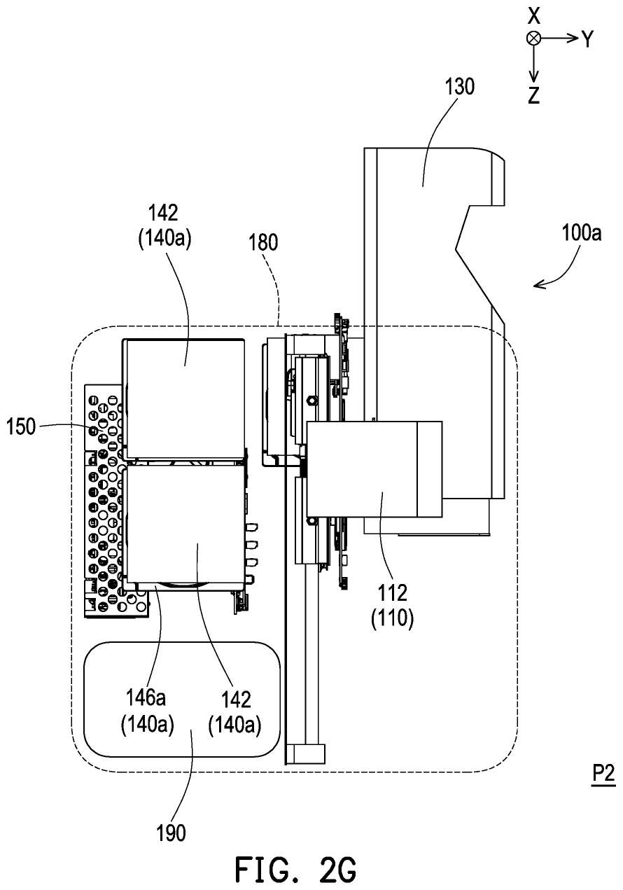

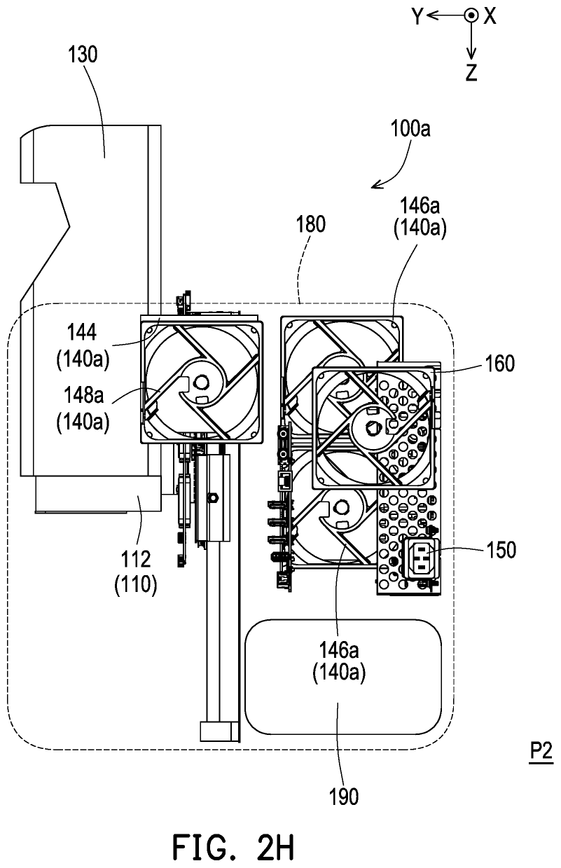

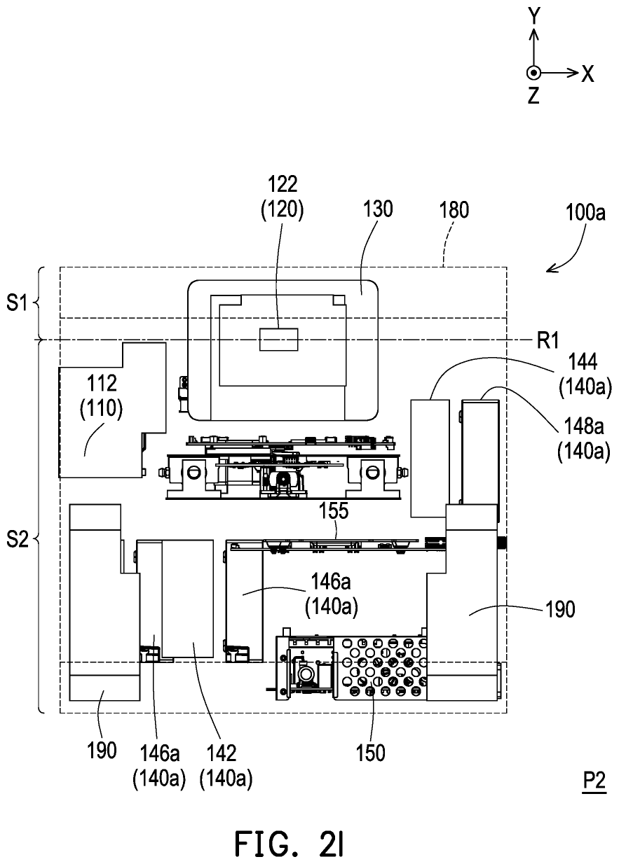

FIG. 1 is a schematic view of a projection apparatus according to an embodiment of the disclosure. FIG. 2A is a schematic perspective view of the projection apparatus of FIG. 1. FIG. 2B is a top view of the projection apparatus of FIG. 2A. FIG. 2C is a left side view of the projection apparatus of FIG. 2A. FIG. 2D is a right side view of the projection apparatus of FIG. 2A. FIG. 2E is a rear view of the projection apparatus of FIG. 2A. FIG. 2F is a top view of a lens module of the projection apparatus of FIG. 2A after being moved. FIG. 2G is a left side view of the lens module of the projection apparatus of FIG. 2A after being moved. FIG. 2H is a right side view of the lens module of the projection apparatus of FIG. 2A after being moved. FIG. 2I is a rear view of the lens module of the projection apparatus of FIG. 2A after being moved. For clarity of description, a casing 180 in FIG. 2A to FIG. 2I is shown with dotted lines.

First, referring to FIG. 1 and FIG. 2A together, in this embodiment, a projection apparatus 100a includes an illumination system 110, an optical engine module 120, a lens module 130, and a heat-dissipation module 140a. The illumination system 110 includes a light source 112, and the illumination system 110 is configured to provide an illumination light beam L1. The optical engine module 120 is disposed on a transmission path of the illumination light beam L1, and is configured to convert the illumination light beam L1 into an image light beam L2. The lens module 130 is disposed on a transmission path of the image light beam L2, and is configured to project the image light beam L2 out of the projection apparatus 100a.

In this embodiment, the light source 112 includes an excitation light source. The excitation light source is light emitting diodes (LEDs), laser diodes (LD), or a combination thereof, for example. The illumination system 110 may also include a wavelength conversion element, a light uniforming element, a filter element, and at least one light guide element. The illumination system 110 is configured to provide light beams of different wavelengths as a source of the illumination light beam L1. Specifically, light sources that the meet volume requirements in the actual design may each be implemented, and the type or form of the illumination system 110 is not specifically limited by the disclosure. The lens module 130 includes, for example, one optical lens element or a combination of a plurality of optical lens elements having refractive power, for example, including various combinations of non-planar lens elements, such as a biconcave lens element, a biconvex lens element, a concavo-convex lens element, a convexo-concave lens element, a plano-convex lens element, and a plano-concave lens element. In an embodiment, the lens module 130 may also include a planar optical lens element, projecting the image light beam L2 from the optical engine module 120 out of the projection apparatus 100a by reflection or transmission. The lens module 130 of this embodiment is embodied as an ultra-short-throw lens.

Next, referring to FIG. 2A, FIG. 2B, and FIG. 2F together, in this embodiment, the lens module 130 has an optical axis X, and the lens module 130 is adapted to move between a first position P1 and a second position P2 along the optical axis X. The heat-dissipation module 140a includes a light source heat-dissipation fin 142, which may be connected to the light source 112 through a heat-conducting element (e.g., a heat pipe). When the lens module 130 moves along the optical axis X, the light source 112, the light source heat-dissipation fin 142, and the optical engine module 120 move together with the lens module 130. More specifically, the moving direction of the light source 112, the light source heat-dissipation fin 142, and the optical engine module 120 is parallel to the optical axis X, such that the light source heat-dissipation fin 142 of the heat-dissipation module 140a effectively dissipates heat from the light source 112.

To be specific, referring to FIG. 2A, FIG. 2B, FIG. 2C, FIG. 2D, and FIG. 2E together, in this embodiment, the optical engine module 120 includes a light valve 122, and the heat-dissipation module 140a further includes a light valve heat-dissipation fin 144. The light valve heat-dissipation fin 144 may be connected to the light valve 122 through a heat-conducting element (e.g., a heat pipe). The light valve 122 is a reflective-type light modulator, for example, a liquid crystal on silicon panel (LCoS panel) or a digital micro-mirror device (DMD). In an embodiment, the light valve 122 is a transmissive-type light modulator, for example, a transparent liquid crystal panel, an electro-optical modulator, a magneto-optic modulator, or an acousto-optic modulator (AOM). Nonetheless, the form and type of the light valve 122 are not limited by this embodiment. For the detailed steps and implementations of the way the light valve 122 converts the illumination light beam L1 (see FIG. 1) into the image light beam L2 (see FIG. 1), sufficient teachings, suggestions, and implementation descriptions may be obtained from common general knowledge in the related technical field, which are thus not repeatedly described here. In addition, in this embodiment, the heat-dissipation module 140a further includes a light source fan 146a and a light valve fan 148a. The light source fan 146a is adjacent to the light source heat-dissipation fin 142. The light valve fan 148a is adjacent to the light valve heat-dissipation fin 144.

Further, as shown in FIG. 2B and FIG. 2E, a first reference plane R1 passes through a geometric center of the optical engine module 120 and divides the optical engine module 120 into an upper side S1 and a lower side S2. Here, at least a part of the optical engine module 120 and at least a part of the lens module 130 are located at the upper side S1, and the heat-dissipation module 140a is located at the lower side S2 of the optical engine module 120. A second reference plane R2 and a third reference plane R3 are respectively located at a front end and a rear end of the optical engine module 120. Positions of the second reference plane R2 and the third reference plane R3 change as the optical engine module 120 moves. A fourth reference plane R4 is perpendicular to the first reference plane R1 and the second reference plane R2, and is located at one side of the illumination system 110. The heat-dissipation module 140a is located between the second reference plane R2 and the third reference plane R3, and an outermost side of the heat-dissipation module 140a does not exceed the fourth reference plane R4. It should be noted here that, FIG. 2B shows that the fourth reference plane R4 is located at the left side of the illumination system 110, and the left side of the heat-dissipation module 140a does not exceed the fourth reference plane R4. Nonetheless, in other embodiments, if the illumination system 110 is located at the right side of the lens module 130, the fourth reference plane R4 is located at the right side of the illumination system 110, and the right side of the heat-dissipation module 140a does not exceed the fourth reference plane R4. In other words, from the top view perspective of FIG. 2B, the lens module 130 of this embodiment is disposed between the light source heat-dissipation fin 142 and the light valve heat-dissipation fin 144 of the heat-dissipation module 140a, a part of the optical engine module 120 and a part of the lens module 130 are located at the upper side S1, and the light source heat-dissipation fin 142, the light valve heat-dissipation fin 144, the light source fan 146a, and the light valve fan 148a are each located at the lower side S2. With this design, the lens module 130 can have the maximum moving range, the projection apparatus 100a can have a system design with the minimum system depth and the minimum system width, and the heat dissipation requirements can also be met.

Next, referring to FIG. 2A, FIG. 2B, FIG. 2C, FIG. 2D, and FIG. 2E together, in this embodiment, the projection apparatus 100a further includes a power supplier 150 and a circuit board 155. The power supplier 150 and the circuit board 155 are disposed at the lower side S2 of the optical engine module 120. Here, the power supplier 150 is a switch mode power supply (SMPS), for example. To enhance heat dissipation efficiency, in this embodiment, the projection apparatus 100a may further include a fan 160, which is adjacent to the power supplier 150, and may dissipate heat from and cool the power supplier 150. Furthermore, in this embodiment, the projection apparatus 100a further includes a casing 180, and the illumination system 110, the optical engine module 120, and the heat-dissipation module 140a are each located within the casing 180. In addition, in this embodiment, the projection apparatus 100a further includes a speaker 190 and an adjustment module 195. The speaker 190 is disposed to the left and right of the lower side S2 of the casing 180. The adjustment module 195 is configured to drive the lens module 130 to move. The adjustment module 195 includes a moving plate 197. The lens module 130 is disposed on the moving plate 197.

Referring to FIG. 2B and FIG. 2E together, when the lens module 130 is located at the first position P1, the lens module 130 is located within the casing 180. Referring to FIG. 2F and FIG. 2I together, when the lens module 130 is located at the second position P2, the lens module 130 protrudes out of the casing 180. Referring to FIG. 2D and FIG. 2E together, the power supplier 150 and the fan 160 are located at the lower right corner of the casing 180, and the light source fan 146a is located at the left side of the fan 160. If the lens module 130 is located at the first position P1 and is in an audio mode where the light source 112 and the light valve 122 of the projection apparatus 100a are not operating and the speaker 190 is operating alone, it is required to only turn on the fan 160 adjacent to the power supplier 150 and one of the light source fan 146a, and the airflow from the light source fan 146a enters from the left side to dissipate heat from and cool the power supplier 150 and the circuit board 155, and the airflow flows out from the right side of the casing 180.

Referring to FIG. 2B, FIG. 2C, FIG. 2D, FIG. 2F, FIG. 2G, and FIG. 2H together, when the lens module 130 moves (e.g., moving from the first position P1 to the second position P2), since the light valve heat-dissipation fin 144 is locked on the optical engine module 120, the light source 112, the light source heat-dissipation fin 142, the light valve 122, and the light valve heat-dissipation fin 144 each moves with the lens module 130 along a direction parallel to the optical axis X. At this time, the light source fan 146a and the light valve fan 148a also move with the lens module 130 along the direction parallel to the optical axis X. Therefore, there is a fixed distance D1 between the light source fan 146a and the light source heat-dissipation fin 142, and there is a fixed distance D2 between the light valve fan 148a and the light valve heat-dissipation fin 144. As shown in FIG. 2E and FIG. 2I, the power supplier 150, the circuit board 155, and the fan 160 do not move together with the lens module 130. In other words, regardless of whether the lens module 130 is located at the first position P1 or the second position P2, the power supplier 150, the circuit board 155, and the fan 160 are continuously retained at their original positions.

It should be noted here that when the lens module 130 is located at the first position P1, the projection apparatus 100a may present the original projection size. When the lens module 130 is located at the second position P2, the projection size of the projection apparatus 100a is enlarged. In addition, when the light source 112 and the light valve 122 of the projection apparatus 100a are turned on and presented in the projection mode, the light source fan 146a, the light valve fan 148a, and the fan 160 are turned on at the same time to cool the light source 112, the light valve 122, the power supplier 150, and the circuit board 155.

In brief, in this embodiment, when the lens module 130 moves along the optical axis X, the light source 112, the light source heat-dissipation fin 142, the light valve 122, and the light valve heat-dissipation fin 144 move together with the lens module 130, such that the heat-dissipation module 140a effectively dissipates heat from the light source 112 and the light valve 122, among other heat sources. Therefore, in this embodiment, the projection apparatus 100a not only moves projection to adjust the size and the focal length of the projection image, but also has a better heat dissipation effect, providing better display quality.

Other embodiments will be identified below for description. It should be noted here that the reference numerals and part of the contents of the above embodiments remain to be used in the following embodiments, where the same reference numerals are adopted to refer to the same or like elements, and descriptions of the same technical contents are omitted. Reference may be made to the above embodiments for the description of the omitted parts, which will not be repeated in the following embodiments.

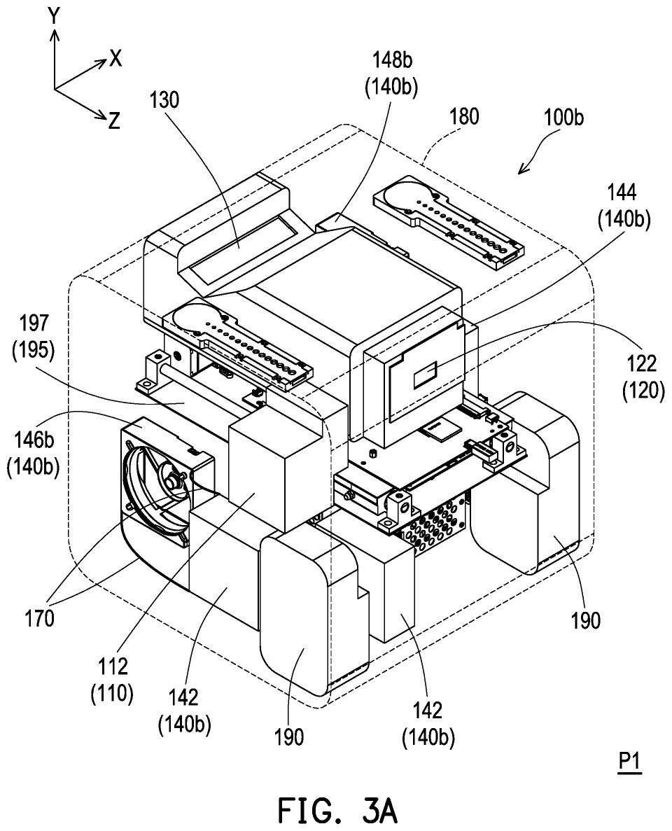

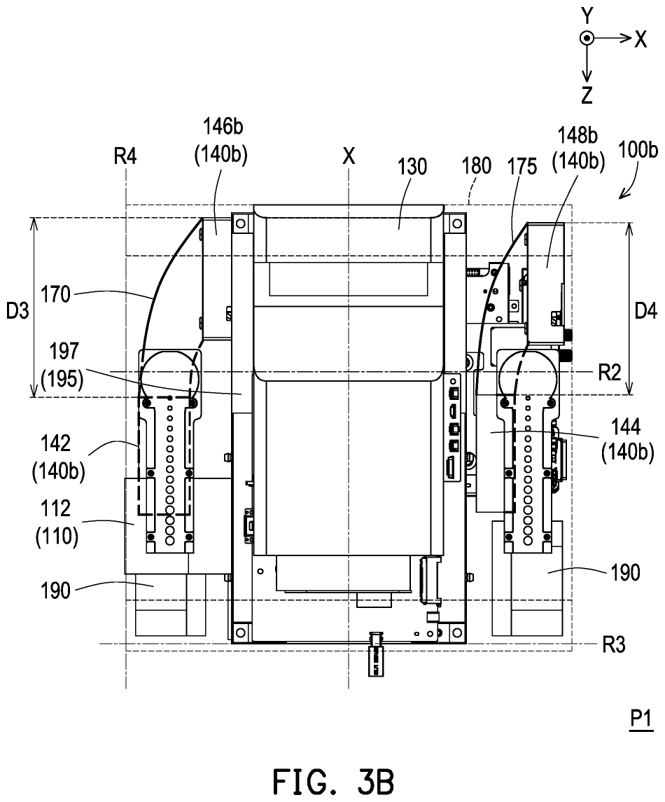

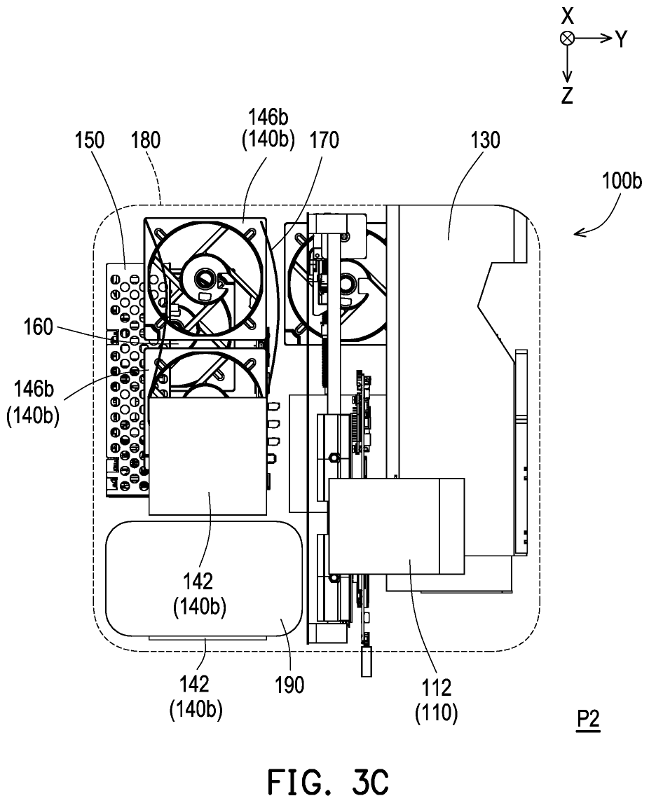

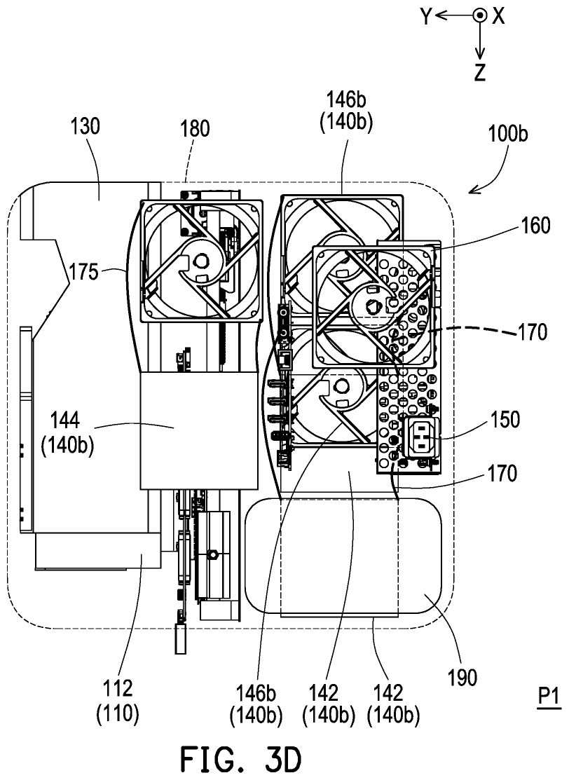

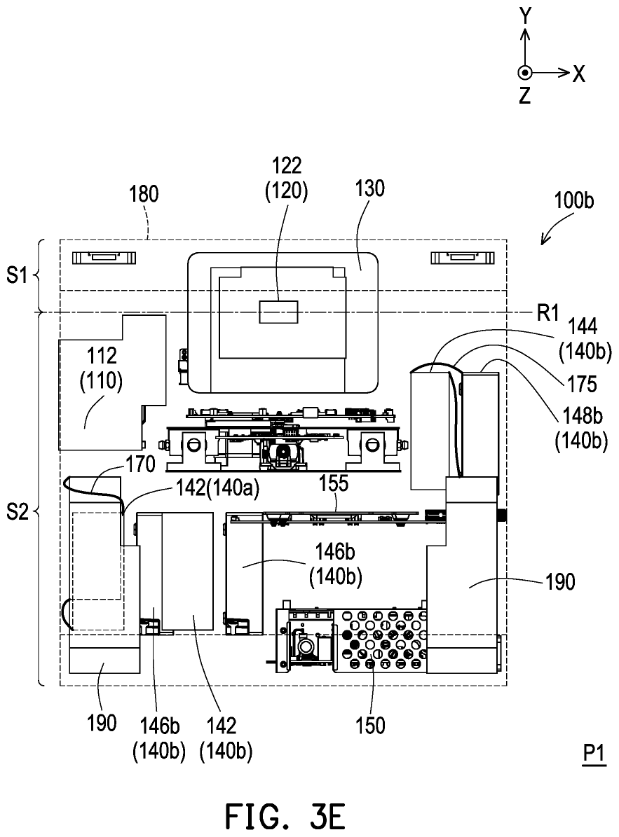

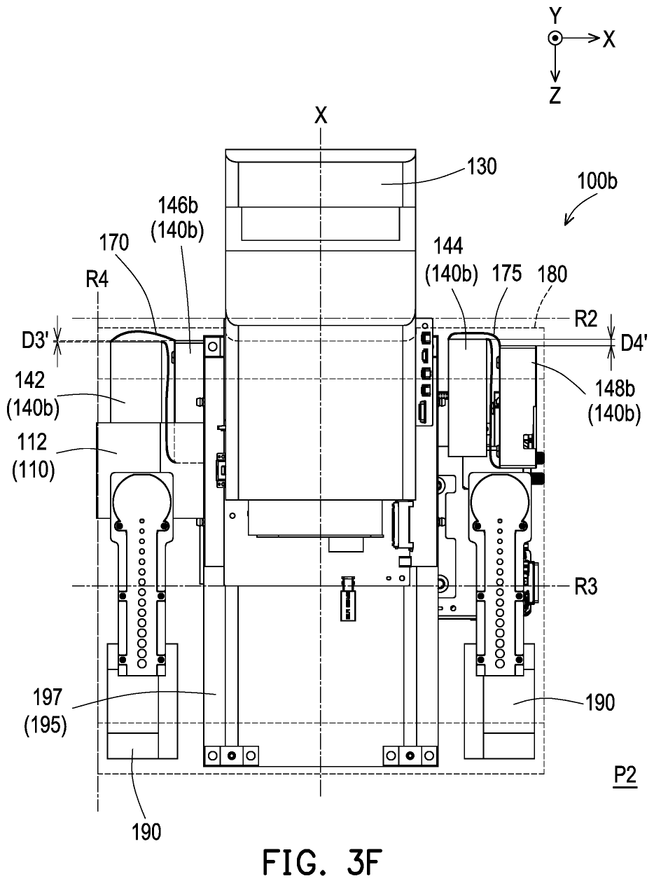

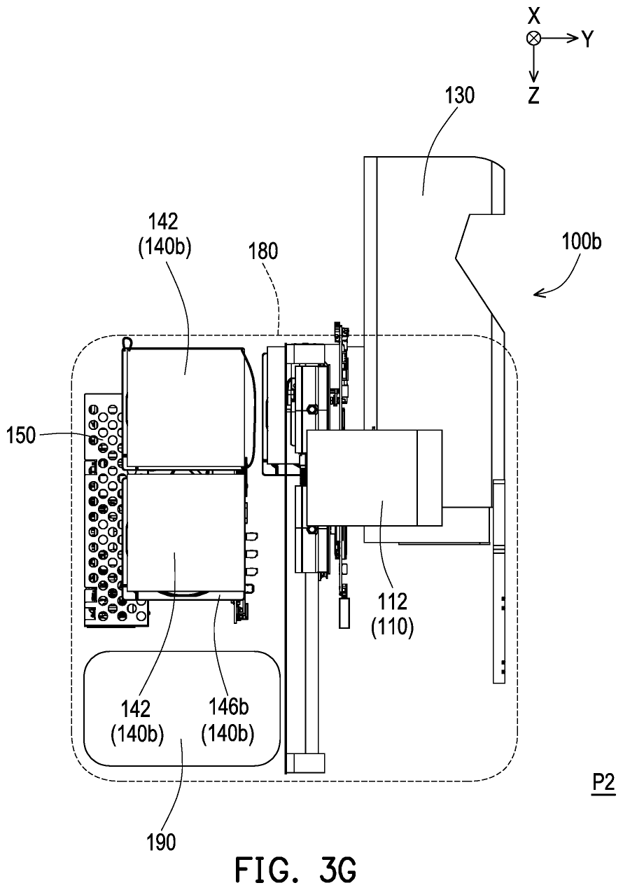

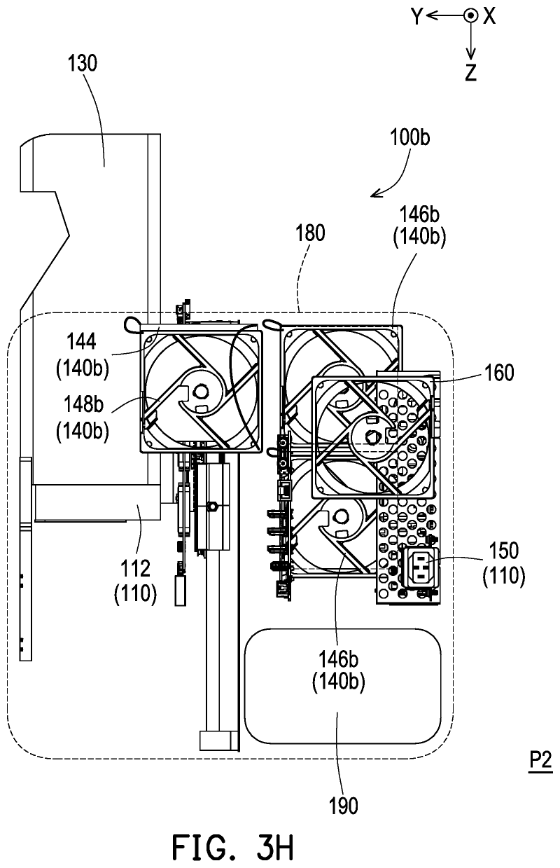

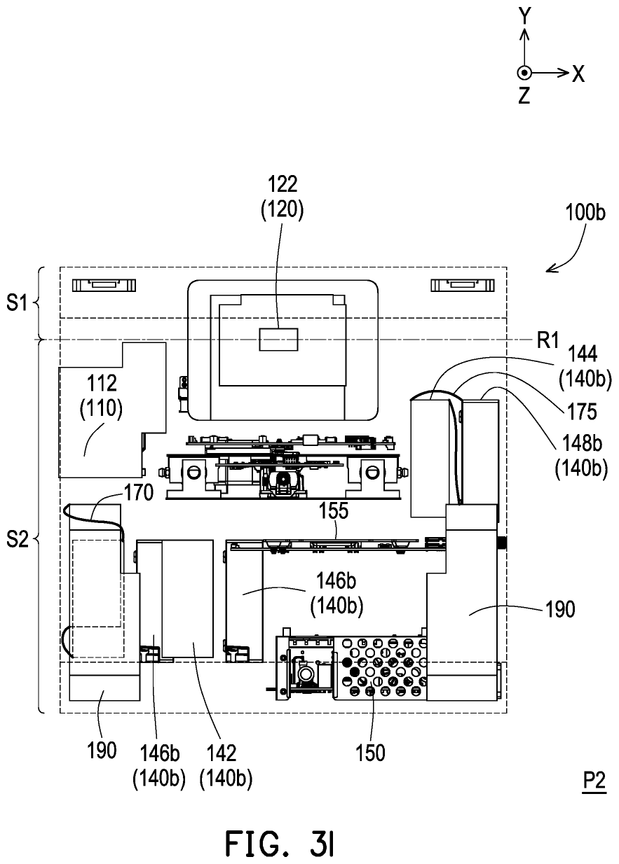

FIG. 3A is a schematic perspective view of a projection apparatus according to another embodiment of the disclosure. FIG. 3B is a top view of the projection apparatus of FIG. 3A. FIG. 3C is a left side view of the projection apparatus of FIG. 3A. FIG. 3D is a right side view of the projection apparatus of FIG. 3A. FIG. 3E is a rear view of the projection apparatus of FIG. 3A. FIG. 3F is a top view of a lens module of the projection apparatus of FIG. 3A after being moved. FIG. 3G is a left side view of the lens module of the projection apparatus of FIG. 3A after being moved. FIG. 3H is a right side view of the lens module of the projection apparatus of FIG. 3A after being moved. FIG. 3I is a rear view of the lens module of the projection apparatus of FIG. 3A after being moved. For clarity of description, a casing 180 in FIG. 3A to FIG. 3I is shown with dotted lines.

First, referring to FIG. 2B, FIG. 2F, FIG. 3B, and FIG. 3F together, a projection apparatus 100b of this embodiment is similar to the projection apparatus 100a in FIG. 2A, while the main differences between them lie in: in this embodiment, when the lens module 130 moves, a light source fan 146b and a light valve fan 148b of a heat-dissipation module 140b do not move together with the lens module 130. In other words, the light source fan 146b and the light valve fan 148b are fixed-type fans, and their positions are fixed and remain unchanged. Here, when the light source fan 146b and the light valve fan 148b are located at the maximum projection image (i.e., the second position P2), they are located at the downstream position of the light source heat-dissipation fin 142 and the light valve heat-dissipation fin 144.

To be specific, referring to FIG. 3A, FIG. 3B, FIG. 3C, FIG. 3D, and FIG. 3E together, in this embodiment, the projection apparatus 100b further includes a first air guide structure 170 and a second air guide structure 175. The first air guide structure 170 is connected to the light source fan 146b and the light source heat-dissipation fin 142. The second air guide structure 175 is connected to the light valve fan 148b and the light valve heat-dissipation fin 144. Here, the material of the first air guide structure 170 and the material of the second air guide structure 175 each comprises mylar, for example.

Referring to FIG. 3B, FIG. 3C, and FIG. 3D together, when the lens module 130 is located at the first position P1, the orthographic projections of the light source fan 146b and the light source heat-dissipation fin 142 on the fourth reference plane R4 do not overlap, and the orthographic projections of the light valve fan 148b and the light valve heat-dissipation fin 144 on the fourth reference plane R4 do not overlap, either.

When referring to FIG. 3B, FIG. 3C, FIG. 3D, FIG. 3E, FIG. 3F, FIG. 3G, FIG. 3H, and FIG. 3I together, when the lens module 130 moves from the first position P1 to the second position P2, a distance D3 between the light source fan 146b and the light source heat-dissipation fin 142 becomes a distance D3′, which means that the distance is gradually reduced, and a distance D4 between the light valve fan 148a and the light valve heat-dissipation fin 144 becomes a distance D4′, which means that the distance is gradually reduced. At this time, an air guide angle of the first air guide structure 170 changes as the light source heat-dissipation fin 142 moves, and an air guide angle of the second air guide structure 175 changes as the light valve heat-dissipation fin 144 moves. In this way, when the lens module 130 moves, the light source fan 146b and the light valve fan 148b may still effectively dissipate heat from respectively the light source heat-dissipation fin 142 and the light valve heat-dissipation fin 144. In addition, when the lens module 130 is located at the second position P2, the orthographic projections of the light source fan 146b and the light source heat-dissipation fin 142 on the fourth reference plane R4 overlap, and the orthographic projections of the light valve fan 148b and the light valve heat-dissipation fin 144 on the fourth reference plane R4 overlap.

In an embodiment not shown, it is also possible not to dispose the air guide structure, and to perform the action of light source power dimming according to the heat dissipation capability of the projection apparatus 100b. As the size of the projection image is reduced, the distance between the fan and the heat-dissipation fin is increased, the cooling effect is worsened, and the power supply is decreased. Under the same brightness intensity (lux or nix), as the size of the projection image is reduced, the brightness (lumen) is decreased, so the usage requirements can also be met.

In summary of the foregoing, the embodiment of the disclosure has at least one of the following advantages or effects. In the design of the projection apparatus of the embodiment of the disclosure, when the lens module moves along the optical axis, the light source, the light source heat-dissipation fin, and the optical engine module also move together with the lens module, such that the heat-dissipation module effectively dissipates heat from the light source. Therefore, the projection apparatus of the embodiment of the disclosure not only moves projection to adjust the size and the focal length of the projection image, but also has a good heat dissipation effect, providing good display quality.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A projection apparatus, comprising:
an illumination system, comprising a light source, and configured to provide an illumination light beam;
an optical engine module, disposed on a transmission path of the illumination light beam, and configured to convert the illumination light beam into an image light beam;
a lens module, disposed on a transmission path of the image light beam, and configured to project the image light beam out of the projection apparatus, wherein the lens module has an optical axis, and the lens module is adapted to move between a first position and a second position along the optical axis; and
a heat-dissipation module, comprising a light source heat-dissipation fin connected to the light source, wherein when the lens module moves, the light source, the light source heat-dissipation fin, and the optical engine module move together with the lens module.

2. The projection apparatus according to claim 1, wherein the optical engine module comprises a light valve, and the heat-dissipation module further comprises a light valve heat-dissipation fin, wherein when the lens module moves, the light valve and the light valve heat-dissipation fin move together with the lens module.

3. The projection apparatus according to claim 2, wherein the heat-dissipation module further comprises:
a light source fan, adjacent to the light source heat-dissipation fin; and
a light valve fan, adjacent to the light valve heat-dissipation fin, wherein when the lens module moves, the light source fan and the light valve fan move together with the lens module.

4. The projection apparatus according to claim 3, wherein there is a fixed distance between the light source fan and the light source heat-dissipation fin, and there is a fixed distance between the light valve fan and the light valve heat-dissipation fin.

5. The projection apparatus according to claim 1, wherein a first reference plane passes through a geometric center of the optical engine module, and divides the optical engine module into an upper side and a lower side, at least a part of the optical engine module and at least a part of the lens module are located at the upper side, and the heat-dissipation module is located at the lower side of the optical engine module.

6. The projection apparatus according to claim 5, wherein a second reference plane and a third reference plane are respectively located at a front end and a rear end of the optical engine module, a fourth reference plane is perpendicular to the first reference plane and the second reference plane, and is located at one side of the illumination system, the heat-dissipation module is located between the second reference plane and the third reference plane, and an outermost side of the heat-dissipation module does not exceed the fourth reference plane.

7. The projection apparatus according to claim 5, further comprising:
a power supplier, disposed at the lower side of the optical engine module; and
a circuit board, disposed at the lower side of the optical engine module, wherein when the lens module moves, the power supplier and the circuit board do not move together with the lens module.

8. The projection apparatus according to claim 7, further comprising:
a fan, adjacent to the power supplier, wherein when the lens module moves, the fan does not move together with the lens module.

9. The projection apparatus according to claim 2, wherein the heat-dissipation module further comprises:
a light source fan; and
a light valve fan, wherein when the lens module moves, the light source fan and the light valve fan do not move together with the lens module.

10. The projection apparatus according to claim 9, further comprising:
a first air guide structure, connected to the light source fan and the light source heat-dissipation fin; and
a second air guide structure, connected to the light valve fan and the light valve heat-dissipation fin, wherein when the lens module moves, an air guide angle of the first air guide structure changes as the light source heat-dissipation fin moves, and an air guide angle of the second air guide structure changes as the light valve heat-dissipation fin moves.

11. The projection apparatus according to claim 10, wherein a material of the first air guide structure and a material of the second air guide structure each comprises mylar.

12. The projection apparatus according to claim 9, wherein when the lens module moves from the first position to the second position, a distance between the light source fan and the light source heat-dissipation fin and a distance between the light valve fan and the light valve heat-dissipation fin are gradually reduced.

13. The projection apparatus according to claim 1, further comprising:
a casing, wherein the illumination system, the optical engine module, and the heat-dissipation module are located within the casing, wherein when the lens module is located at the first position, the lens module is located within the casing, and when the lens module is located at the second position, the lens module protrudes out of the casing.
